(19) United States
(12) Patent Application Publication
(10) Pub. No.: US 2012/0116045 A1
(43) Pub. Date: May 10, 2012

(54) Liquid Crystal Alignment Agent, Liquid Crystal Alignment Film Manufactured Using the Same, and Liquid Crystal Display Device Including the Liquid Crystal Alignment Film

(75) Inventors: Tae-Hyoung KWAK, Uiwang-si (KR); Bum-Jin LEE, Uiwang-si (KR); Won-Seok DONG, Uiwang-si (KR); Yo-Choul PARK, Uiwang-si (KR); Hyo-Ju SEO, Uiwang-si (KR); Hwan-Sung CHEON, Uiwang-si (KR); Won-Ho CHOI, Uiwang-si (KR)

(73) Assignee: Cheil Industries Inc., Gumi-si (KR)

(21) Appl. No.: 13/162,607

(22) Filed: Jun. 17, 2011

(30) Foreign Application Priority Data
Nov. 5, 2010 (KR) 10-2010-0109809

(51) Int. Cl. C08G 73/10; C08G 63/66

(52) U.S. Cl. 528/170; 528/208

(57) ABSTRACT

Disclosed is a liquid crystal alignment agent including a polymer including polyamic acid including a repeating unit represented by Chemical Formula 1, polyimide including a repeating unit represented by Chemical Formula 2, or a combination thereof.

### CROSS-REFERENCE TO RELATED APPLICATION

This application claims priority under 35 USC Section 119 to and the benefit of Korean Patent Application No. 10-2010-0109809 filed in the Korean Intellectual Property Office on Nov. 05, 2010, the entire disclosure of which is incorporated herein by reference.

### FIELD OF THE INVENTION

The present invention relates to a liquid crystal alignment agent, a liquid crystal alignment film manufactured using the same, and a liquid crystal display device including the liquid crystal alignment film.

### BACKGROUND OF THE INVENTION

### Description of the Related Art

A liquid crystal display (LCD) includes a liquid crystal alignment film. The liquid crystal alignment film is primarily made of polymer materials. The liquid crystal alignment film directs the alignment of liquid crystal molecules. When the liquid crystal molecules are moved by the influence of an electric field to display an image, the liquid crystal alignment film allows the liquid crystal molecules to be oriented in a predetermined direction. Generally, it is necessary to uniformly align the liquid crystal molecules in order to provide uniform brightness and a high contrast ratio to the LCD.

Increasing demand for LCDs has increased the need for high quality LCDs. In addition, since LCDs are rapidly becoming larger, there is an increasing requirement for a highly productive liquid crystal alignment film. Accordingly, there is also a need for a liquid crystal alignment film having a low defect rate during the LCD manufacturing process, excellent electro-optical characteristics, high reliability, and high performance that satisfies different characteristics for various developing LCDs.

### SUMMARY OF THE INVENTION

The present invention provides a liquid crystal alignment agent that includes a polymer prepared using diamine containing a functional group that is reactive to light irradiation, which can improve transmittance and response rate; provide excellent electrical properties such as voltage holding ratio and residual DC; and provide easy control of the pretilt angle.

The present invention also provides a liquid crystal alignment film manufactured using the liquid crystal alignment agent.

The present invention further provides a liquid crystal display device including the liquid crystal alignment film.

The liquid crystal alignment agent of the invention includes a polymer comprising polyamic acid including a repeating unit represented by the following Chemical Formula 1, polyimide including a repeating unit represented by the following Chemical Formula 2, or a combination thereof.

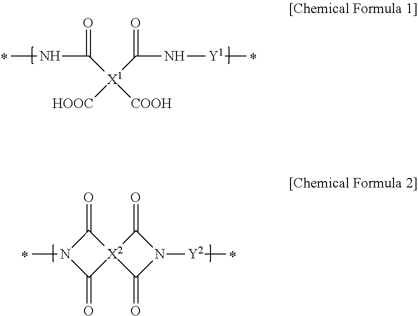

In Chemical Formulae 1 and 2,

X¹ and X² are the same or different and are each independently a tetravalent organic group derived from alicyclic acid dianhydride or aromatic acid dianhydride, and

Y¹ and Y² are the same or different and are each independently a divalent organic group derived from diamine, wherein the diamine includes a diamine represented by the following Chemical Formula 3.

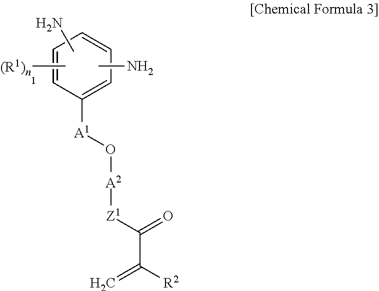

In Chemical Formula 3,

each R¹ is independently hydrogen, substituted or unsubstituted C1 to C30 aliphatic organic group, or substituted or unsubstituted C2 to C30 aromatic organic group,

n₁ is an integer ranging from 0 to 3,

A¹ is substituted or unsubstituted C1 to C20 alkylene,

A² is a single bond, substituted or unsubstituted divalent C1 to C20 aliphatic organic group, substituted or unsubstituted divalent C2 to C30 aromatic organic group, or substituted or unsubstituted divalent C3 to C30 alicyclic organic group,

Z¹ is a single bond, oxygen (O), substituted or unsubstituted divalent C1 to C20 aliphatic organic group, substituted or unsubstituted divalent C2 to C30 aromatic organic group, or substituted or unsubstituted divalent C3 to C30 alicyclic organic group, and

R² is hydrogen (H) or methyl (CH₃).

Examples of the diamine represented by the above Chemical Formula 3 may include a compound represented by one of the following Chemical Formulae 4 to 8 and combinations thereof.

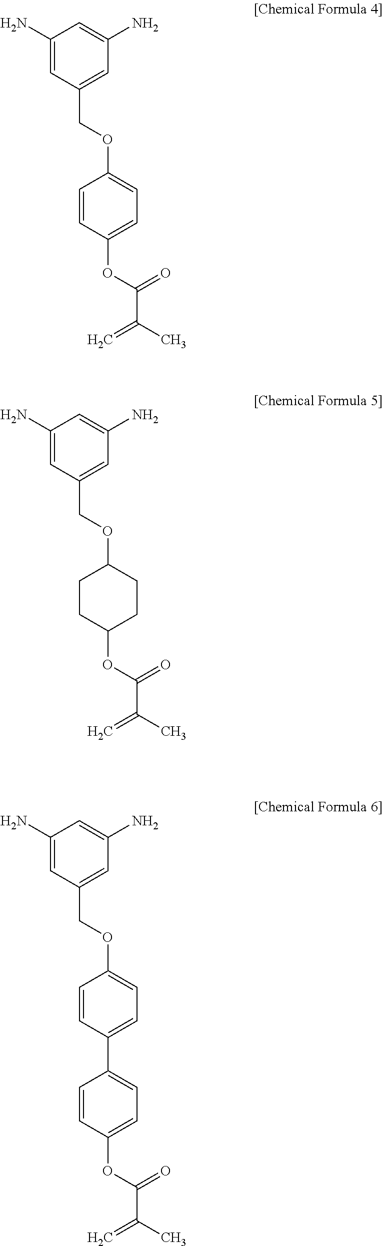

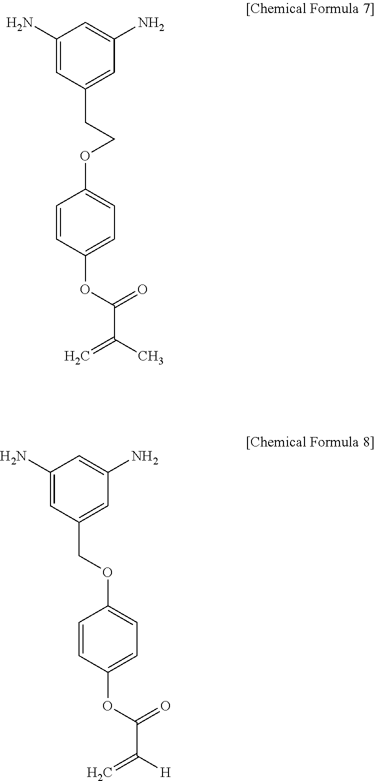

The diamine may further include an aromatic diamine represented by one or more of the following Chemical Formulae 16 to 19, a functional diamine represented by one or more of the following Chemical Formulae 20 to 22, or a combination thereof.

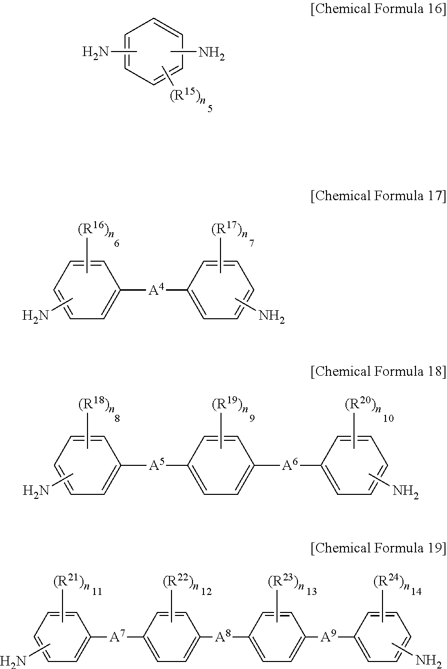

In Chemical Formulae 16 to 19,

R¹⁵ to R²⁴ are the same or different and are each independently substituted or unsubstituted alkyl, substituted or unsubstituted ‘aryl, or substituted or unsubstituted heteroaryl, wherein each of the alkyl, aryl, and heteroaryl may optionally include —O—, —COO—, —CONH—, —OCO—, or a combination thereof,

A⁴ to A⁹ are the same or different and are each independently a single bond, O, SO₂ or C(R¹⁰³)(R¹⁰⁴), wherein R¹⁰³ and R¹⁰⁴ are the same or different and are each independently hydrogen or substituted or unsubstituted C1 to C6 alkyl, and

n₅ to n₁₄ are each independently integers ranging from 0 to 4.

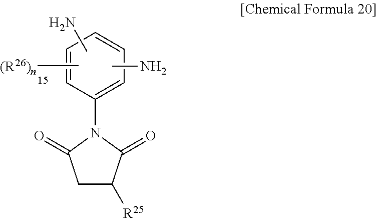

In Chemical Formula 20,

R²⁵ is hydrogen, substituted or unsubstituted C1 to C30 alkyl, substituted or unsubstituted C6 to C30 aryl, or substituted or unsubstituted C2 to C30 heteroaryl,

each R²⁶ is the same or different and is each independently substituted or unsubstituted C1 to C30 alkyl, substituted or unsubstituted C6 to C30 aryl, or substituted or unsubstituted C2 to C30 heteroaryl, and

n₁₅ is an integer ranging from 0 to 3.

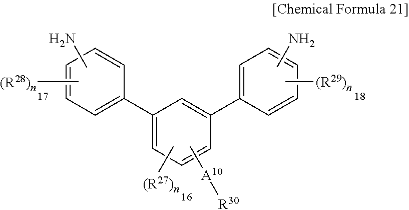

In Chemical Formula 21,

R²⁷, R²⁸ and R²⁹ are the same or different and are each independently substituted or unsubstituted alkyl, substituted or unsubstituted aryl, or substituted or unsubstituted heteroaryl,

A¹⁰ is a single bond, O, COO, CONH, OCO, or substituted or unsubstituted C1 to C10 alkylene,

R³⁰ is hydrogen, substituted or unsubstituted alkyl, substituted or unsubstituted aryl, or substituted or unsubstituted heteroaryl, wherein each of the alkyl, aryl, and heteroaryl may optionally include —O—, —COO—, —CONH—, —OCO—, or a combination thereof,

n₁₆ is an integer ranging from 0 to 3, and

n₁₇ and n₁₈ are each independently integers ranging from 0 to 4.

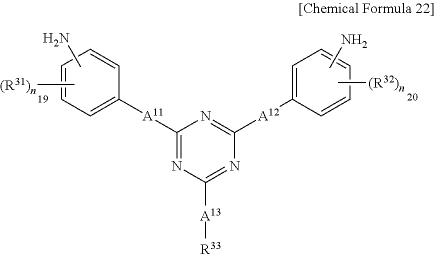

In Chemical Formula 22,

R³¹ and R³² are the same or different and are each independently substituted or unsubstituted alkyl, substituted or unsubstituted aryl, or substituted or unsubstituted heteroaryl,

n₁₉ and n₂₀ are each independently integers ranging from 0 to 4,

R³³ is hydrogen, substituted or unsubstituted alkyl, substituted or unsubstituted aryl, or substituted or unsubstituted heteroaryl,

A¹¹ and A¹² are the same or different and are each independently a single bond, O, or COO, and

A¹³ is a single bond, O, COO, CONH, or OCO.

When the diamine includes the aromatic diamine and functional diamine as well as a diamine represented by the above Chemical Formula 3, the diamine represented by the above Chemical Formula 3 may be included in an amount of about 1 mol % to about 70 mol %, the aromatic diamine may be included in an amount of about 5 mol % to about 80 mol %, and the functional diamine may be included in an amount of about 1 mol % to about 50 mol %, based on the total amount of diamine.

The polyamic acid may have a weight average molecular weight (Mw) of about 10,000 to about 300,000.

The polyimide may have a weight average molecular weight of about 10,000 to about 300,000.

When the liquid crystal alignment agent includes both the polyamic acid and the polyimide, the polyamic acid and the polyimide may be included at a weight ratio of about 1:99 to about 50:50.

The liquid crystal alignment agent may include about 1 wt % to about 25 wt % of a solid content.

The present invention further provides a liquid crystal alignment film manufactured by applying the liquid crystal alignment agent to a substrate.

The present invention further provides a liquid crystal display device including the liquid crystal alignment film.

Hereinafter, further aspects of the present invention will be described in detail.

The liquid crystal alignment agent of the invention can improve transmittance, response rate, liquid crystal alignment properties, and electro-optical characteristics of a film made using the same and further can provide easy control of the pretilt angle. Accordingly, the liquid crystal alignment agent may be used in vertical alignment mode (VA mode) liquid crystal alignment films and twisted nematic mode (TN mode) liquid crystal alignment films.

### DETAILED DESCRIPTION

The present invention will be described more fully hereinafter in the following detailed description of the invention, in which some but not all embodiments of the invention are described. Indeed, this invention may be embodied in many different forms and should not be construed as limited to the embodiments set forth herein; rather, these embodiments are provided so that this disclosure will satisfy applicable legal requirements.

As used herein, when a specific definition is not otherwise provided, the term “substituted” may refer to one substituted with a substituent comprising halogen (F, Br, Cl or I), a hydroxy group, a nitro group, a cyano group, an amino group (NH₂, NH(R¹⁰⁰) or N(R¹⁰¹)(R¹⁰²), wherein R¹⁰⁰, R¹⁰¹, and R¹⁰² are the same or different and are each independently a C1 to C10 alkyl group), an amidino group, a hydrazine group, a hydrazone group, a carboxyl group, a substituted or unsubstituted alkyl group, a substituted or unsubstituted haloalkyl group, a substituted or unsubstituted alkoxy group, a substituted or unsubstituted alicyclic organic group, a substituted or unsubstituted aryl group, a substituted or unsubstituted alkenyl group, a substituted or unsubstituted alkynyl group, a substituted or unsubstituted heteroaryl group, a substituted or unsubstituted heterocycloalkyl group, or a combination thereof, replacing a corresponding number of hydrogen atoms.

As used herein, when a specific definition is not provided, the term “alkyl” may refer to C1 to C30 alkyl, for example C1 to C20 alkyl, the term “cycloalkyl” may refer to C3 to C30 cycloalkyl, for example C3 to C20 cycloalkyl, the term “heterocycloalkyl” may refer to C2 to C30 heterocycloalkyl, for example C2 to C20 heterocycloalkyl, the term “alkylene” may refer to C1 to C30 alkylene, for example C1 to C20 alkylene, the term “alkoxy” may refer to C1 to C30 alkoxy, for example C1 to C20 alkoxy, the term “cycloalkylene” may refer to C3 to C30 cycloalkylene, for example C3 to C20 cycloalkylene, the term “heterocycloalkylene” may refer to C2 to C30 heterocycloalkylene, for example C2 to C20 heterocycloalkylene, the term “aryl” may refer to C6 to C30 aryl, for example C6 to C20 aryl, the term “heteroaryl” may refer to C2 to C30 heteroaryl, for example C2 to C18 heteroaryl, the term “arylene” may refer to C6 to C30 arylene, for example C6 to C20 arylene, the term “heteroarylene” may refer to C2 to C30 heteroarylene, for example C2 to C20 heteroarylene, the term “alkylaryl” may refer to C7 to C30 alkylaryl, for example C7 to C20 alkylaryl, and the term “halogen” may refer to F, Cl, Br, I, or a combination thereof.

As used herein, when a specific definition is not otherwise provided, heterocycloalkyl, heterocycloalkylene, heteroaryl, and heteroarylene refer to cycloalkyl, cycloalkylene, aryl, and arylene, respectively, in which 1 to 3 carbon ring atoms are replaced with 1 to 3 heteroatoms comprising N, O, S, Si, P, or a combination thereof.

As used herein, when a specific definition is not otherwise provided, the term “aliphatic” refers to C1 to C30 alkyl, C2 to C30 alkenyl, C2 to C30 alkynyl, C1 to C30 alkylene, C2 to C30 alkenylene, or C2 to C30 alkynylene, for example C1 to C20 alkyl, C2 to C20 alkenyl, C2 to C20 alkynyl, C1 to C20 alkylene, C2 to C20 alkenylene, or C2 to C20 alkynylene; the term “alicyclic” refers to C3 to C30 cycloalkyl, C3 to C30 cycloalkenyl, C3 to C30 cycloalkynyl, C3 to C30 cycloalkylene, C3 to C30 cycloalkenylene, or C3 to C30 cycloalkynylene, for example C3 to C20 cycloalkyl, C3 to C20 cycloalkenyl, C3 to C20 cycloalkynyl, C3 to C20 cycloalkylene, C3 to C20 cycloalkenylene, or C3 to C20 cycloalkynylene; and the term “aromatic” refers to C6 to C30 aryl, C2 to C30 heteroaryl, C6 to C30 arylene, or C2 to C30 heteroarylene, for example C6 to C16 aryl, C2 to C16 heteroaryl, C6 to C16 arylene, or C2 to C16 heteroarylene.

As used herein, when a specific definition is not otherwise provided, the term “combination” may refer to a mixture or copolymerization (or copolymer); and in the case of an alicyclic organic group and an aromatic organic group, a fused ring of two or more rings, or two or more rings linked by a single bond, O, S, C(═O), CH(OH), S(═O), S(═O)₂, Si(CH₃)₂, (CH₂)ₚ (wherein, 1≦p≦2), (CF₂)_{q} (wherein, 1≦q≦2), C(CH₃)₂, C(CF₃)₂, C(CH₃)(CF₃), or C(═O)NH. Herein, “copolymerization” may refer to block copolymerization or to random copolymerization, and “copolymer” may refer to a block copolymer or to a random copolymer.

“*” denotes a position linked to the same or different atom or Chemical Formula.

The liquid crystal alignment agent according to one embodiment of the present invention includes a polymer comprising polyamic acid including a repeating unit represented by the following Chemical Formula 1, polyimide including a repeating unit represented by the following Chemical Formula 2, or a combination thereof.

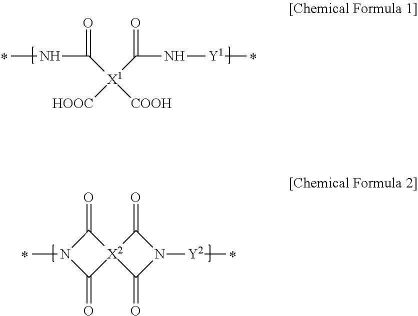

In Chemical Formulae 1 and 2,

X¹ and X² are the same or different and are each independently a tetravalent organic group derived from alicyclic acid dianhydride or aromatic acid dianhydride. X¹ may be the same or different in each repeating unit, and X² may be the same or different in each repeating unit.

Y¹ and Y² are the same or different and are each independently a divalent organic group derived from diamine, wherein the diamine includes a diamine represented by the following Chemical Formula 3. Y¹ may be the same or different in each repeating unit, and Y² may be the same or different in each repeating unit.

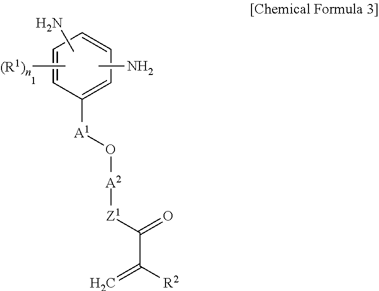

In Chemical Formula 3,

each R¹ is independently hydrogen, substituted or unsubstituted C1 to C30 aliphatic organic group, or substituted or unsubstituted C2 to C30 aromatic organic group.

n₁ is an integer ranging from 0 to 3.

A¹ is substituted or unsubstituted C1 to C20 alkylene, for example substituted or unsubstituted C1 to C10 alkylene, and as another example substituted or unsubstituted C1 to C5 alkylene.

A² is a single bond, substituted or unsubstituted divalent C1 to C20 aliphatic organic group, substituted or unsubstituted divalent C2 to C30 aromatic organic group, or substituted or unsubstituted divalent C3 to C30 alicyclic organic group, for example substituted or unsubstituted C1 to C20 alkylene, substituted or unsubstituted C6 to C30 arylene, or substituted or unsubstituted C3 to C30 cycloalkylene.

Z¹ is a single bond, oxygen (0), substituted or unsubstituted divalent C1 to C20 aliphatic organic group, substituted or unsubstituted divalent C2 to C30 aromatic organic group, or substituted or unsubstituted divalent C3 to C30 alicyclic organic group, for example a single bond, oxygen, substituted or unsubstituted C1 to C20 alkylene, substituted or unsubstituted C6 to C30 arylene, or substituted or unsubstituted C3 to C30 cycloalkylene, and as another example oxygen.

R² is hydrogen (H) or methyl (CH₃).

The diamine represented by the above Chemical Formula 3 includes a residual group derived from acrylate or methacrylate at its terminal end, and the residual group derived from acrylate or methacrylate undergoes a reaction by photo-radiation. Accordingly, when the liquid crystal alignment agent is prepared by using the diamine represented by Chemical Formula 3, it may induce the molecular alignment of liquid crystal to one direction during the irradiation, so it may effectively improve the alignment properties.

Specifically, the diamine represented by the above Chemical Formula 3 may include a compound represented by the following Chemical Formulae 4 to 8, or a combination thereof, but is not limited thereto.

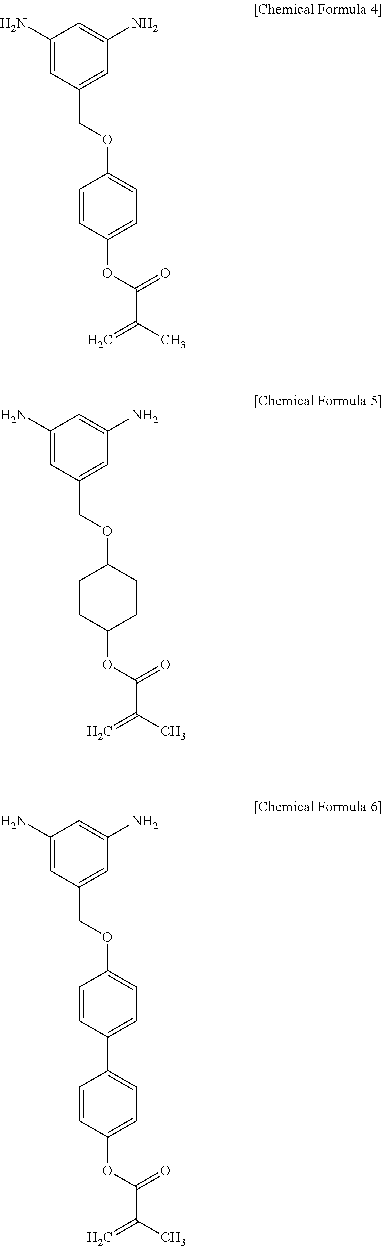

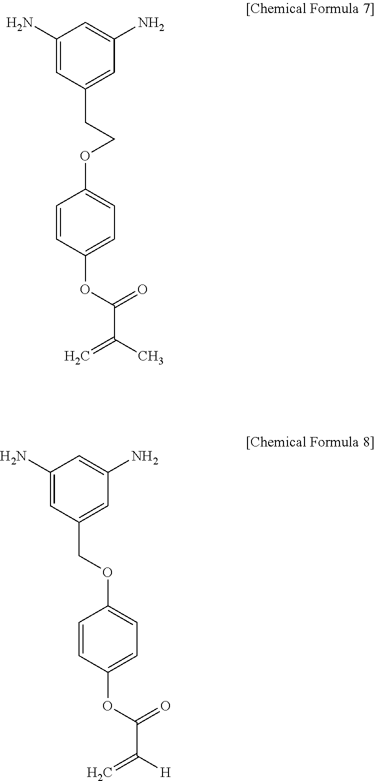

When both the polyamic acid and the polyimide are present, the polyamic acid and the polyimide may be simply mixed or copolymerized.

Hereinafter, each component is described in detail.

Polymer

The polymer includes polyamic acid including a repeating unit represented by Chemical Formula 1, polyimide including a repeating unit represented by Chemical Formula 2, or a combination thereof.

The polyamic acid including a repeating unit represented by Chemical Formula 1 may be synthesized from acid dianhydride and diamine. The method of preparing polyamic acid by copolymerizing the acid dianhydride and the diamine is not specifically limited as long as it synthesizes the polyamic acid.

The polyimide including a repeating unit represented by Chemical Formula 2 may be prepared by imidizing the polyamic acid including a repeating unit represented by Chemical Formula 1.

Methods for preparing polyamic acid and preparing polyimide by imidizing polyamic acid are well known in the art and can be accomplished by the skilled artisan without undue experimentation.

The acid dianhydride may include alicyclic acid dianhydride, aromatic acid dianhydride, or a mixture thereof.

The diamine may include diamine represented by Chemical Formula 3 or a mixture of the same with at least one of a predetermined functional diamine, a predetermined aromatic diamine, or a combination of the predetermined functional diamine and predetermined aromatic diamine.

Examples of the alicyclic acid dianhydride may include without limitation 1,2,3,4-cyclobutanetetracarboxylic acid dianhydride (CBDA), 5-(2,5-dioxotetrahydrofuryl)-3-methylcyclohexene-1,2-dicarboxylic acid anhydride (DOCDA), bicyclooctene-2,3,5,6-tetracarboxylic acid dianhydride (BODA), 1,2,3,4-cyclopentanetetracarboxylic acid dianhydride (CPDA), 1,2,4,5-cyclohexanetetracarboxylic acid dianhydride (CHDA), 1,2,4-tricarboxy-3-methylcarboxy cyclopentane dianhydride, 1,2,3,4-tetracarboxy cyclopentane dianhydride, and the like, and combinations thereof.

The tetravalent organic group derived from the alicyclic acid dianhydride may include a functional group represented by one or more of the following Chemical Formulae 9 to 13, but is not limited thereto.

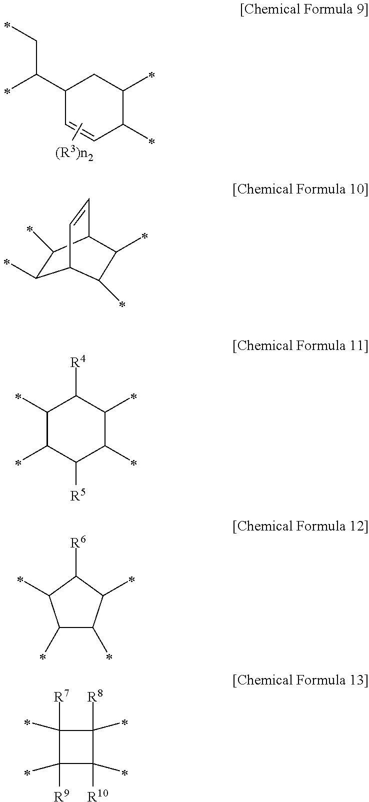

In Chemical Formulae 9 to 13,

each R³ is the same or different and is each independently substituted or unsubstituted alkyl, substituted or unsubstituted aryl, or substituted or unsubstituted heteroaryl,

n₂ is an integer ranging from 0 to 3,

each R⁴ to R¹⁰ is the same or different and is each independently hydrogen, substituted or unsubstituted alkyl, substituted or unsubstituted aryl, or substituted or unsubstituted heteroaryl.

When n₂ is an integer of 2 or more, a plurality of R³ may be the same or different.

Examples of the aromatic acid dianhydride may include without limitation pyromellitic acid dianhydride (PMDA), biphthalic acid dianhydride (BPDA), oxydiphthalic acid dianhydride (ODPA), benzophenonetetracarboxylic acid dianhydride (BTDA), hexafluoroisopropylidene diphthalic acid dianhydride (6-FDA), and the like, and combinations thereof.

The tetravalent organic group derived from the aromatic acid dianhydride may include a functional group represented by the following Chemical Formula 14, and a functional group represented by the following Chemical Formula 15, or a combination thereof, but is not limited thereto.

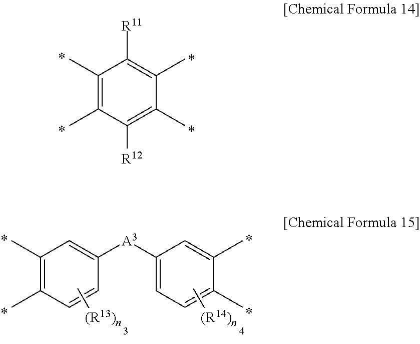

In Chemical Formulae 14 and 15,

R¹¹ and R¹² are the same or different and are each independently hydrogen, substituted or unsubstituted alkyl, substituted or unsubstituted aryl, or substituted or unsubstituted heteroaryl,

R¹³ and R¹⁴ are the same or different and are each independently substituted or unsubstituted alkyl, substituted or unsubstituted aryl, or substituted or unsubstituted heteroaryl,

n₃ and n₄ are each independently integers ranging from 0 to 3, and

A³ is a single bond, O, CO, substituted or unsubstituted C1 to C6 alkylene (e.g., C(CF₃)₂), substituted or unsubstituted C3 to C30 cycloalkylene, or substituted or unsubstituted C2 to C30 heterocycloalkylene.

When n₃ is an integer of 2 or more, a plurality of R¹³ may be the same or different. When n₄ is an integer of 2 or more, a plurality of R¹⁴ may be the same or different.

Examples of the aromatic diamine may include without limitation paraphenylenediamine (p-PDA), 4,4-methylene dianiline (MDA), 4,4-oxydianiline (ODA), metabisaminophenoxydiphenylsulfone (m-BAPS), parabisaminophenoxydiphenylsulfone (p-BAPS), 2,2-bis[(aminophenoxy)phenyl]propane (BAPP), 2,2-bisaminophenoxyphenylhexafluoropropane (HF-BAPP), 1,4-diamino-2-methoxybenzene, and the like, and combinations thereof.

The aromatic diamine may include one or more of the compounds represented by the following Chemical Formulae 16 to 19, but is not limited thereto. The polyamic acid and the polyimide may include a divalent organic group derived from the aromatic diamine. When the polyamic acid and the polyimide include the divalent organic group derived from the aromatic diamine, the liquid crystal alignment agent and/or the liquid crystal alignment film formed from the liquid crystal alignment agent may exhibit improved chemical resistance, thermal stability, and mechanical characteristics.

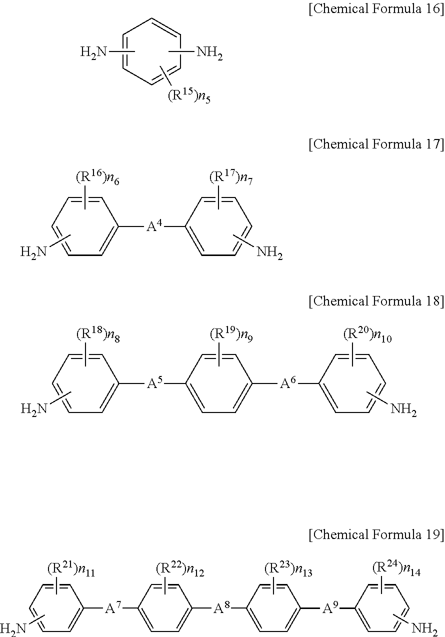

In Chemical Formulae 16 to 19,

R¹⁵ to R²⁴ are the same or different and are each independently substituted or unsubstituted alkyl, substituted or unsubstituted aryl, or substituted or unsubstituted heteroaryl, wherein the alkyl, aryl, and heteroaryl may optionally include —O—, —COO—, —CONH—, —OCO—, or a combination thereof,

A⁴ to A⁹ are the same or different and are each independently a single bond, O, SO₂ or C(R¹⁰³)(R¹⁰⁴), for example C(CF₃)₂, wherein R¹⁰³ and R¹⁰⁴ are the same or different and are each independently hydrogen or substituted or unsubstituted C1 to C6 alkyl, and

n₅ to n₁₄ are each independently integers ranging from 0 to 4.

When n₅ is an integer of 2 or more, a plurality of R¹⁵ may be the same or different. When n₆ to n₁₄ are an integer of 2 or more, a plurality of R¹⁶ to R²⁴ may be the same or different, respectively.

The functional diamine may include one or more compounds represented by the following Chemical Formulae 20 to 22, but is not limited thereto. The polyamic acid and the polyimide may include a divalent organic group derived from the functional diamine. When the polyamic acid and the polyimide include the divalent organic group derived from the functional diamine, the liquid crystal alignment agent and/or the liquid crystal alignment film formed from the liquid crystal alignment agent may exhibit improved liquid crystal alignment properties, chemical resistance, and electro-optical characteristics, and it may also allow easier control of pretilt angle and accomplish a high pretilt angle. Accordingly, the liquid crystal alignment agent may be used in a vertical alignment mode liquid crystal alignment film and a twisted nematic mode liquid crystal alignment film.

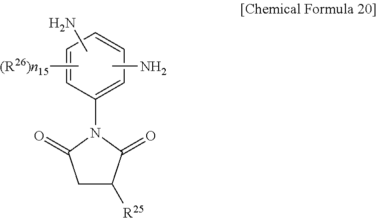

In Chemical Formula 20,

R²⁵ is hydrogen, substituted or unsubstituted C1 to C30 alkyl, substituted ‘or unsubstituted C6 to C30 aryl, or substituted or unsubstituted C2 to C30 heteroaryl,

each R²⁶ is the same or different and each is independently substituted or unsubstituted C1 to C30 alkyl, substituted or unsubstituted C6 to C30 aryl, or substituted or unsubstituted C2 to C30 heteroaryl, and

n₁₅ is an integer ranging from 0 to 3.

When n₁₅ is an integer of 2 or more, a plurality of R²⁶ may be the same or different.

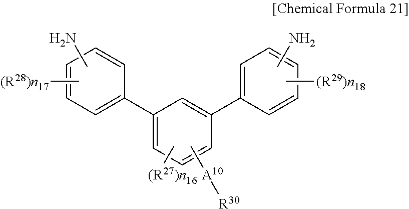

In Chemical Formula 21,

R²⁷, R²⁸ and R²⁹ are the same or different and are each independently substituted or unsubstituted alkyl, substituted or unsubstituted aryl, or substituted or unsubstituted heteroaryl,

A¹⁰ is a single bond, O, COO, CONH, OCO, or substituted or unsubstituted C1 to C10 alkylene,

R³⁰ is hydrogen, substituted or unsubstituted alkyl, substituted or unsubstituted aryl, or substituted or unsubstituted heteroaryl, wherein the alkyl, aryl, and heteroaryl may optionally include —O—, —COO—, —CONH—, —OCO—, or a combination thereof,

n₁₆ is an integer ranging from 0 to 3, and

n₁₇ and n₁₈ are each independently integers ranging from 0 to 4.

When n₁₆ is an integer of 2 or more, a plurality of R²⁷ may be the same or different. When n₁₇ and n₁₈ are integers of 2 or more, a plurality of R²⁸ and R²⁹ may be the same or different, respectively.

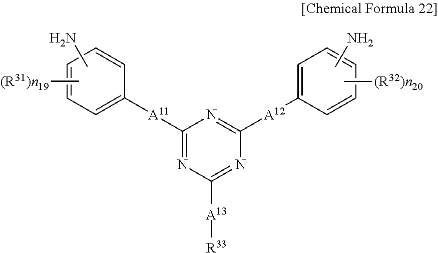

In Chemical Formula 22,

R³¹ and R³² are the same or different and are each independently substituted or unsubstituted alkyl, substituted or unsubstituted aryl, or substituted or unsubstituted heteroaryl,

n₁₉ and n₂₀ are each independently integers ranging from 0 to 4,

R³³ is hydrogen, substituted or unsubstituted alkyl, substituted or unsubstituted aryl, or substituted or unsubstituted heteroaryl,

A¹¹ and A¹² are the same or different and are each independently a single bond, O, or COO, and

A¹³ is a single bond, O, COO, CONH, or OCO.

When n₁₉ is an integer of 2 or more, a plurality of R³¹ may be the same or different. When n₂₀ is an integer of 2 or more, a plurality of R³² may be the same or different.

The diamine may include only diamine represented by the above Chemical Formula 3, or it may also include one or both of the aromatic diamine and the functional diamine together with the diamine represented by the above Chemical Formula 3.

When the diamine includes the aromatic diamine and/or the functional diamine as well as diamine represented by the above Chemical Formula 3, the diamine represented by the above Chemical Formula 3 is included in an amount of about 1 mol% to about 70 mol %; the aromatic diamine is included in an amount of in about 5 mol% to about 80 mol %; and the functional diamine is included in an amount of about 1 mol % to about 50 mol %, based on the total amount of diamine.

In some embodiments, the diamine can include the diamine represented by the above Chemical Formula 3 in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 mol %. Further, according to some embodiments of the present invention, the amount of the diamine represented by the above Chemical Formula 3 can be in a range from about any of the foregoing amounts to about any other of the foregoing amounts.

In some embodiments, the diamine can include the aromatic diamine in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80 mol %. Further, according to some embodiments of the present invention, the amount of the aromatic diamine can be in a range from about any of the foregoing amounts to about any other of the foregoing amounts.

In some embodiments, the diamine can include the functional diamine in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 mol %. Further, according to some embodiments of the present invention, the amount of the functional diamine can be in a range from about any of the foregoing amounts to about any other of the foregoing amounts.

When each diamine is included in an amount within these ranges, the liquid crystal alignment agent may control the pretilt angle and effectively accomplish high pretilt angle; and it may also exhibit improved liquid crystal alignment properties, chemical resistance, electro-optical characteristics, thermal stability, and mechanical characteristics. Additionally, the process may be improved by increasing the solubility.

The polyamic acid may have a weight average molecular weight of about 10,000 to about 300,000. The polyimide may have a weight average molecular weight of about 10,000 to about 300,000. When the polyamic acid and the polyimide have a weight average molecular weight within these ranges, the liquid crystal alignment agent may effectively improve reliability and electro-optical characteristics, provide excellent chemical resistance, and maintain the stable pretilt angle even after driving the liquid crystal display device.

When the liquid crystal alignment agent includes both the polyamic acid and the polyimide, the liquid crystal alignment agent may include the polyamic acid and the polyimide in a weight ratio of about 1:99 to about 50:50. For example, the polyamic acid and the polyimide can be included in a weight ratio of about 10:90 to about 50:50.

In some embodiments, the mixture of polyamic acid and polyimide can include polyamic acid in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt %. Further, according to some embodiments of the present invention, the amount of polyamic acid can be in a range from about any of the foregoing amounts to about any other of the foregoing amounts.

In some embodiments, the mixture of polyamic acid and polyimide can include polyimide in an amount of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99 wt %. Further, according to some embodiments of the present invention, the amount of polyimide can be in a range from about any of the foregoing amounts to about any other of the foregoing amounts.

When the polyamic acid and the polyimide are included in a weight ratio within these ranges, the liquid crystal alignment agent may improve alignment stability.

The liquid crystal alignment agent may include the polymer in an amount of about 1 wt % to about 25 wt %, for example, about 3 wt % to about 20 wt %. In some embodiments, the liquid crystal alignment agent may include the polymer in an amount of about 1, 2, 3, 4, 5, 6, 7, 8, 9, 10, 11, 12, 13, 14, 15, 16, 17, 18, 19, 20, 21, 22, 23, 24, or 25 wt %. Further, according to some embodiments of the present invention, the amount of polymer can be in a range from about any of the foregoing amounts to about any other of the foregoing amounts.

When the polymer is included in an amount within these ranges, the liquid crystal alignment agent may improve printability and liquid crystal alignment properties.

Solvent

The-liquid crystal alignment agent according to one embodiment of the present invention can further include a suitable solvent to dissolve the polymer.

Examples of solvents suitable for dissolving the polymer may include without limitation N-methyl-2-pyrrolidone; N,N-dimethyl acetamide; N,N-dimethyl formamide; dimethyl sulfoxide; γ-butyrolactone; tetrahydrofuran (THF); and a phenol-based solvent such as meta cresol, phenol, halogenated phenol, and the like, and combinations thereof.

The solvent may further include 2-butyl cellosolve (2-BC), which may improve printability. 2-butyl cellosolve may be included in an amount of about 1 wt % to about 60 wt %, for example about 10 wt % to about 60 wt %, based on the total weight of the solvent including 2-butyl cellosolve. In some embodiments, the solvent may include 2-butyl cellosolve in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 wt %. Further, according to some embodiments of the present invention, the amount of 2-butyl cellosolve can be in a range from about any of the foregoing amounts to about any other of the foregoing amounts. Including 2-butyl cellosolve in an amount within these ranges may improve printability.

In addition, the solvent may further include a poor solvent. Examples of the poor solvent may include without limitation alcohols, ketones, esters, ethers, hydrocarbons, halogenated hydrocarbons, and the like, and combinations thereof. The solvent may include a poor solvent in an appropriate ratio as long as the soluble polyimide polymer is not precipitated. The poor solvents can decrease the surface energy of the liquid crystal alignment agent to improve the spreadability and the flatness during the coating.

The poor solvent may be included in an amount of about 1 wt % to about 90 wt %, for example, about 1 wt % to about 70 wt %, based on the total weight of solvent including the poor solvent. In some embodiments, the solvent may include the poor solvent in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 wt %. Further, according to some embodiments of the present invention, the amount of poor solvent can be in a range from about any of the foregoing amounts to about any other of the foregoing amounts.

Examples of the poor solvent may include without limitation methanol, ethanol, isopropanol, cyclohexanol, ethylene glycol, propylene glycol, 1,4-butanediol, triethylene glycol, acetone, methylethylketone, cyclohexanone, methylacetate, ethylacetate, butylacetate, diethyloxalate, malonic acid ester, diethylether, ethylene glycol monomethylether, ethyleneglycol dimethylether, ethylene glycol monoethylether, ethylene glycol phenylether, ethylene glycol phenylmethylether, ethylene glycol phenylethylether, diethylene glycol dimethylether, diethylene glycol ether, diethylene glycol monomethylether, diethylene glycol monoethylether, diethylene glycol monomethylether acetate, diethylene glycol monoethylether acetate, ethylene glycol methylether acetate, ethylene glycol ethylether acetate, 4-hydroxy-4-methyl-2-pentanone, 2-hydroxy ethyl propionate, 2-hydroxy-2-methyl ethyl propionate, ethoxy ethyl acetate, hydroxy ethyl acetate, 2-hydroxy-3-methyl methyl butanoate, 3-methoxy methyl propionate, 3-methoxy ethyl propionate, 3-ethoxy ethyl propionate, 3-ethoxy methyl propionate, methyl methoxy butanol, ethyl methoxy butanol, methyl ethoxy butanol, ethyl ethoxy butanol, tetrahydrofuran, dichloromethane, 1,2-dichloroethane, 1,4-dichlorobutane, trichloroethane, chlorobenzene, o-dichlorobenzene, hexane, heptane, octane, benzene, toluene, xylene, and the like, and combinations thereof.

Although the amount of solvent is not specifically limited in the liquid crystal alignment agent, the liquid crystal alignment agent may include the solvent in an amount sufficient to provide a solid content of about 1 wt % to about 25 wt %, for example about 1 wt % to about 20 wt %. In some embodiments, the solvent may be present in the liquid crystal aligment agent in an amount sufficient to provide a solid content of about 1, 2, 3, 4, 5, 6, 7, 8, 9, 10, 11, 12, 13, 14, 15, 16, 17, 18, 19, 20, 21, 22, 23, 24, or 25 wt %. Further, according to some embodiments of the present invention, the amount of solvent can be an amount sufficient to provide a solid content in a range from about any of the foregoing amounts to about any other of the foregoing amounts.

When the solid amount is within these ranges, the polluting property of the substrate surface is less affected during the printing process to suitably maintain the uniformity of the layer. Thereby, it may prevent the deterioration of layer uniformity due to high viscosity during the printing process and to provide an appropriate transmittance.

Other Additive(s)

The liquid crystal alignment agent according to one embodiment may further include one or more other additives.

For example, the liquid crystal aligment agent may further include an epoxy compound. The epoxy compound can improve the reliability and the electro-optical characteristics of the product. The epoxy compound may include one or more epoxy compounds having 2 to 8 epoxy groups, for example, 2 to 4 epoxy groups.

The liquid crystal aligment agent may include the epoxy compound in an amount of about 0.1 parts by weight to about 50 parts by weight, for example about 1 part by weight to about 30 parts by weight, based on 100 parts by weight of the polymer. In some embodiments, the liquid crystal aligment agent may include the epoxy compound in an amount of about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 parts by weight. Further, according to some embodiments of the present invention, the amount of the epoxy compound can be in a range from about any of the foregoing amounts to about any other of the foregoing amounts.

A liquid crystal alignment agent including the epoxy compound in an amount within these ranges can exhibit appropriate printability and flatness during coating on the substrate, and can also improve reliability and electro-optical characteristics. Examples of the epoxy compound may include without limitation a compound or a combination of compounds represented by the following Chemical Formula 23.

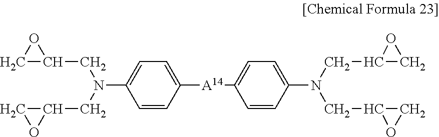

In Chemical Formula 23,

A¹⁴ is substituted or unsubstituted C6 to C12 aromatic organic group, substituted or unsubstituted divalent C6 to C12 alicyclic organic group, or substituted or unsubstituted divalent C6 to C12 aliphatic organic group, for example substituted or unsubstituted C1 to C6 alkylene.

Examples of the epoxy compound may include without limitation N,N,N′, N′-tetraglycidyl-4,4′-diaminophenylmethane (TGDDM), N,N,N′, N′-tetraglycidyl-4,4′-diaminophenylethane, N,N,N′, N′-tetraglycidyl-4,4′-diaminophenylpropane, N,N,N′,N′-tetraglycidyl-4,4′-diaminophenylbutane, N,N,N′,N′-tetraglycidyl-4,4′-diaminobenzene, ethyleneglycoldiglycidylether, polyethyleneglycoldiglycidylether, propyleneglycoldiglycidylether, tripropyleneglycoldiglycidylether, polypropyleneglycoldiglycidylether, neopentylglycoldiglycidylether, 1,6-hexanedioldiglycidylether, glycerinediglycidylether, 2,2-dibromoneopentylglycoldiglycidylether, 1,3,5,6-tetraglycidyl-2,4-hexanediol, N,N,N′, N′-tetraglycidyl-1,4-phenylenediamine, N,N,N′, N′-tetraglycidyl-m-xylenediamine, N,N,N′, N′-tetraglycidyl-2,2′-dimethyl-4,4′-diaminobiphenyl, 2,2-bis[4-(N,N-diglycidyl-4-aminophenoxy)phenyl]propane, N,N,N′,N′-tetraglycidyl-4,4′-diaminodiphenylmethane, 1,3-bis(N,N-diglycidylaminomethyl)cyclohexane, 1,3-bis(N,N-diglycidylaminomethyl)benzene, and the like, and combinations thereof.

The liquid crystal aligment agent may also optionally include other appropriate additives to improve printability, such as but not limited to a surfactant or a coupling agent. Such additives can be used in conventional amounts.

The liquid crystal alignment film according to another embodiment may be manufactured using the liquid crystal alignment agent.

The liquid crystal alignment film may be formed by coating the liquid crystal alignment agent on a substrate. Exemplary methods for coating the liquid crystal alignment agent on the substrate may include without limitation spin coating, flexo printing, inkjet printing, and the like. For example, flexo printing may be generally used since it can provide excellent uniformity of the formed coating layer and can also easily provide a large size print.

The substrate is not specifically limited as long as it has a high transparency. Non-limiting examples of the substrate include a glass substrate or a plastic substrate such as an acrylic substrate or a polycarbonate substrate, and the like. In addition, the substrate can be formed with an indium-tin oxide (ITO) electrode or the like for driving the liquid crystal, which can simplify processes of making and/or using the coated substrate.

In order to increase the coating uniformity, the method of making the liquid crystal alignment film can further include a pre-drying step. The pre-drying step can be conducted at a temperature ranging from about room temperature to about 200° C., for example, about 30° C. to about 150° C., or about 40° C. to about 120° C. for about 1 minute to about 100 minutes after uniformly coating the liquid crystal alignment agent on the substrate. The pre-drying process may control volatilization of each component of the liquid crystal alignment agent, which can help provide a more uniform coating layer having no or minimal deviation in the thickness (or change in the thickness) thereof.

Then the coated substrate may be baked at a temperature of about 80° C. to about 300° C., for example, a temperature of about 120° C. to about 280° C. for about 5 minutes to about 300 minutes to evaporate the solvent and to provide a liquid crystal alignment film.

According to further another embodiment of the present invention, a liquid crystal display device is provided that includes the liquid crystal alignment film.

### EXAMPLE

The following examples illustrate this disclosure in more detail. However, they are exemplary embodiments of this disclosure and are not limiting.

### Synthesis Example 1

### Preparation of 4-(3,5-diaminobenzyloxy)phenyl methacrylate

### Step 1: Preparation of 1-(bromomethyl)-3,5-dinitrobenzene and 4-(tert-butyldimethylsilyloxy)phenol

350 g (1.8 mmol) of (3,5-dinitrophenyl)methanol and 6 L of dichloromethane are introduced into a 10 L flask under nitrogen atmosphere and 555 g (2.2 mmol) of triphenyl phosphine (PPh₃) is added thereto in a dropwise fashion at room temperature. Then 377 g (2.2 mmol) of N-bromo succinimide (NBS) is slowly added thereto in a dropwise fashion and the reactants are agitated for 2 hours. After completing the reaction, 4 L of water are introduced into the reaction product and an organic layer including the reaction product is recovered. Then the organic layer is washed with 4 L of saturated NaCl aqueous solution and filtered and concentrated under reduced pressure to provide 1-(bromomethyl)-3,5-dinitrobenzene in about 76% yield.

200 g (1.8 mmol) of hydroquinone and 2 L of tetrahydrofuran (THF) are introduced into a 5 L flask under nitrogen atmosphere and 87 g (3.0 mmol) of sodium hydride (NaH) are slowly added thereto in a dropwise fashion at room temperature. Subsequently, a solution in which 273 g (3.0 mmol) of tert-butyldimethylsilylchloride is dissolved into 1.2 L of tetrahydrofuran (THF) is slowly added thereto in a dropwise fashion and the reactants are agitated for 4 hours at room temperature. After completing the reaction, 7 L of water and 1 L of ethylacetate are added into the reaction product and an organic layer including the reaction product is recovered. Then the organic layer is washed with 4 L of saturated NaCl aqueous solution and concentrated under reduced pressure to provide 4-(tert-butyldimethylsilyloxy)phenol in about 80% yield.

### Step 2: Preparation of tert-butyl (4-(3,5-dinitrobenzyloxy)phenoxy)dimethylsilane

345 g (1.321 mmol) of 1-(bromomethyl)-3,5-dinitrobenzene, 326 g (1.453 mmol) of 4-(tert-butyldimethylsilyloxy)phenol, 273.9 g (2.0 mmol) of potassium carbonate (K₂CO₃), and 22 g (0.14 mmol) of potassium iodide (KI) are introduced into a 5 L flask under nitrogen atmosphere, 5.3 L of dimethyl formamide (DMF) are added thereto, and the reactants are agitated at 60° C. for 2 hours. After completing the reaction, 4 L of water and 5 L of ethyl acetate are added to the reaction product and an organic layer including the reaction product is recovered. Then the organic layer is further washed with water twice and washed with 4 L of saturated NaCl aqueous solution and concentrated under reduced pressure to provide tert-butyl (4-(3,5-dinitrobenzyloxy)phenoxy)dimethylsilane in about 71% yield.

### Step 3: Preparation of tert-butyl-5-((4-hydroxyphenoxy)methyl)-1,3-phenylenedicarbamate

100 g (0.247 mmol) of tert-butyl(4-(3,5-dinitrobenzyloxy)phenoxy)dimethylsilane, 502 g (2.3 mmol) of SnCl₂.2H₂O, 1 L of tetrahydrofuran (THF), and 1 L of water (H₂O) are introduced into a 5 L flask under nitrogen atmosphere and agitated for 6 hours under 60° C. reflux. After completing the reaction, 2 L of water, 1 L of ethyl acetate, and 2 kg of celite are added to the reaction product and saturated sodium hydrogen carbonate (NaHCO₃) is slowly added thereto in a dropwise fashion. The sodium hydrogen carbonate is added in a dropwise fashion until the pH is 7 to 8, and the celite is filtered. An organic layer including the reaction product is recovered from the filtered solution.

Then the organic layer is concentrated under reduced pressure. Under nitrogen atmosphere, 0.247 mmol of the concentrated compound is introduced into a 5 L flask, 3 L of tetrahydrofuran (THF) and 161.7 g (0.74 mmol) of di-tert-butoxypyrocarbonate ((Boc)₂O) are added thereto, and the reactants are agitated at room temperature for 8 hours. After completing the reaction, 2 L of water and 2 L of ethyl acetate, are added to the reaction product and an organic layer including the reaction product is recovered. Then the organic layer is further washed with water twice and concentrated under reduced pressure to provide tert-butyl-5-((4-hydroxyphenoxy) methyl)-1,3-phenylenedicarbamate in about 90% yield.

### Step 4: Preparation of 4-(3,5-bis(tert-butoxycarbonylamino)benzyloxy)phenyl methacrylate

Under nitrogen atmosphere, 106 g (0.25 mmol) of tert-butyl-5-((4-hydroxyphenoxy)methyl)-1,3-phenylenedicarbamate, 1.5 L of tetrahydrofuran (THF), 106 ml of stabilizer, 35 g (0.3 mmol) of Hunig base, and 3 g (0.024 mmol) of 4-dimethylaminopyridine (DMAP) are introduced into a 5 L flask. Then 37.9 g (0.246 mmol) of methacrylic anhydride is slowly added thereto in a dropwise fashion and the reactants are agitated at room temperature. 2 L of water and 2 L of ethylacetate are added thereto and an organic layer including the reaction product is recovered. Then the organic layer is concentrated under reduced pressure to provide 4-(3,5-bis(tert-butoxycarbonylamino)benzyloxy)phenyl methacrylate in about 80% yield.

### Step 5: Preparation of 4-(3,5-diaminobenzyloxy)phenyl methacrylate

103 g (0.206 mmol) of 4-(3,5-bis(tert-butoxycarbonylamino)benzyloxy)phenyl methacrylate, 122 ml of stabilizer, and 1.1 L of dichloromethane are introduced into a 5 L flask under nitrogen atmosphere. Then 376.8 g (3.30 mmol) of trifluoroacetic acid (TFA) is slowly added thereto in a dropwise fashion at 25° C. and the reactants agitated at room temperature. After completing the reaction, 4 L of saturated sodium hydrogen carbonate (NaHCO₃) and 2 L of ethylacetate are added thereto and an organic layer including the reaction product is recovered. Then the organic layer is further washed with water one more time and concentrated under reduced pressure and recrystallized with ether and filtered to provide 4-(3,5-diaminobenzyloxy)phenyl methacrylate represented by the following Chemical Formula 4 in about 50% yield.

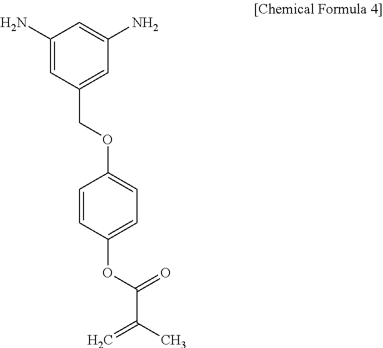

### Example 1

### Preparation of Liquid Crystal Alignment Agent Including Polyimide (PSPI-1)

0.79 mol of p-phenylenediamine, 0.2 mol of 3,5-diaminophenyldecyl succinimide which is a functional diamine represented by the following Chemical Formula 24, and 0.01 mol of 4-(3,5-diaminobenzyloxy)phenyl methacrylate are introduced into a four-neck flask mounted with an agitator, a temperature controller, a nitrogen gas injector, and a condenser while passing nitrogen therethrough and N-methyl-2-pyrrolidone (NMP) is added to provide a mixed solution.

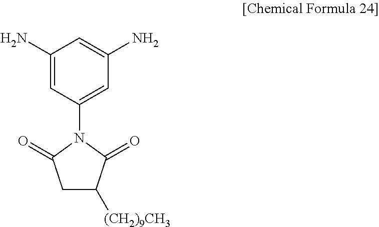

1.0 mol of solid 1,2,3,4-cyclobutanetetracarboxylic acid dianhydride is added into the mixed solution and the mixed solution is vigorously agitated. The solid content is 20 wt %, the reaction is performed for 10 hours while maintaining the temperature from 30° C. to 50° C. N-methyl-2-pyrrolidone is added thereto and the reactants are agitated at room temperature for 24 hours to provide a polyamic acid solution.

3.0 mol of acetic acid anhydride and 5.0 mol of pyridine are added into the obtained polyamic acid solution and heated to 80° C. and reacted for 6 hours. Then the catalyst and the solvent are removed through vacuum distillation to provide a polyimide solution having a solid content of 20%. A mixed organic solvent (volume ratio=50:40:10) of N-methyl-2-pyrrolidone, γ-butyrolactone, and 2-butylcellosolve is added thereto and the reactants are agitated at a room temperature for 24 hours to provide a liquid crystal alignment agent including polyimide (PSPI-1). The obtained liquid crystal alignment agent has a solid content of 10 wt %. In addition, the polyimide (PSPI-1) has a weight average molecular weight of 200,000.

### Example 2

### Preparation of Liquid Crystal Alignment Agent Including Polyimide (PSPI-2)

A liquid crystal alignment agent including polyimide (PSPI-2) is prepared in accordance with the same procedure as in Example 1, except that a functional diamine represented by the following Chemical Formula 25 is used instead of the functional diamine represented by Chemical Formula 24. The obtained liquid crystal alignment agent has a solid content of 10 wt %. In addition, the polyimide (PSPI-2) has a weight average molecular weight of 190,000.

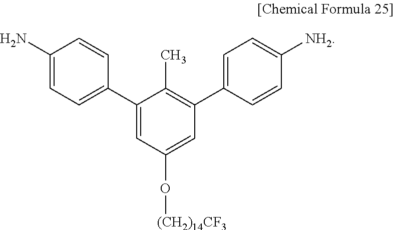

### Example 3

### Preparation of Liquid Crystal Alignment Agent Including Polyimide (PSPI-3)

A liquid crystal alignment agent including polyimide (PSPI-3) is prepared in accordance with the same procedure as in Example 1, except that a functional diamine represented by the following Chemical Formula 26 is used instead of the functional diamine represented by Chemical Formula 24. The obtained liquid crystal alignment agent has a solid content of 10 wt %. In addition, the polyimide (PSPI-3) has a weight average molecular weight of 190,000.

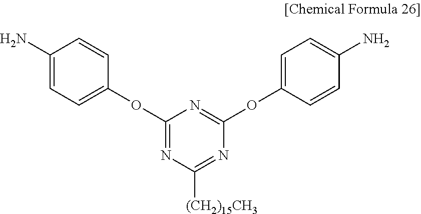

### Example 4

### Preparation of Liquid Crystal Alignment Agent Including Polyimide (PSPI-4)

A liquid crystal alignment agent including polyimide (PSPI-4) is prepared in accordance with the same procedure as in Example 1, except that 0.5 mol of para-phenylenediamine, 0.2 mol of a functional diamine represented by Chemical Formula 24, and 0.3 mol of 4-(3,5-diaminobenzyloxy)phenyl methacrylate are used. The obtained liquid crystal alignment agent has a solid content of 10 wt %. In addition, the polyimide (PSPI-4) has a weight average molecular weight of 200,000.

### Example 5

### Preparation of Liquid Crystal Alignment Agent Including Polyimide (PSPI-5)

A liquid crystal alignment agent including polyimide (PSPI-5) is prepared in accordance with the same procedure as in Example 2, except that 0.5 mol of para-phenylenediamine, 0.2 mol of a functional diamine represented by Chemical Formula 25, and 0.3 mol of 4-(3,5-diaminobenzyloxy)phenyl methacrylate are used. The obtained liquid crystal alignment agent has a solid content of 10 wt %. In addition, the polyimide (PSPI-5) has a weight average molecular weight of 210,000.

### Example 6

### Preparation of Liquid Crystal Alignment Agent Including Polyimide (PSPI-6)

A liquid crystal alignment agent including polyimide (PSPI-6) is prepared in accordance with the same procedure as in Example 3, except that 0.5 mol of para-phenylenediamine, 0.2 mol of a functional diamine represented by Chemical Formula 26, and 0.3 mol of 4-(3,5-diaminobenzyloxy)phenyl methacrylate are used. The obtained liquid crystal alignment agent has a solid content of 10 wt %. In addition, the polyimide (PSPI-6) has a weight average molecular weight of 190,000.

### Example 7

### Preparation of Liquid Crystal Alignment Agent Including Polyimide (PSPI-7)

A liquid crystal alignment agent including polyimide (PSPI-7) is prepared in accordance with the same procedure as in Example 1, except that 0.1 mol of para-phenylenediamine, 0.2 mol of a functional diamine represented by Chemical Formula 24, and 0.7 mol of 4-(3,5-diaminobenzyloxy)phenyl methacrylate are used. The obtained liquid crystal alignment agent has a solid content of 10 wt %. In addition, the polyimide (PSPI-7) has a weight average molecular weight of 180,000.

### Example 8

### Preparation of Liquid Crystal Alignment Agent Including Polyimide (PSPI-8)

A liquid crystal alignment agent including polyimide (PSPI-8) is prepared in accordance with the same procedure as in Example 2, except that 0.1 mol of para-phenylenediamine, 0.2 mol of a functional diamine represented by Chemical Formula 25, and 0.7 mol of 4-(3,5-diaminobenzyloxy)phenyl methacrylate are used. The obtained liquid crystal alignment agent has a solid content of 10 wt %. In addition, the polyimide (PSPI-8) has a weight average molecular weight of 200,000.

### Example 9

### Preparation of Liquid Crystal Alignment Agent Including Polyimide (PSPI-9)

A liquid crystal alignment agent including polyimide (PSPI-9) is prepared in accordance with the same procedure as in Example 3, except that 0.1 mol of para-phenylenediamine, 0.2 mol of a functional diamine represented by Chemical Formula 26, and 0.7 mol of 4-(3,5-diaminobenzyloxy)phenyl methacrylate are used. The obtained liquid crystal alignment agent has a solid content of 10 wt %. In addition, the polyimide (PSPI-9) has a weight average molecular weight of 190,000.

### Example 10

### Preparation of Liquid Crystal Alignment Agent Including Polyimide (PSPI-10)

A liquid crystal alignment agent including polyimide (PSPI-10) is prepared in accordance with the same procedure as in Example 1, except that 0.3 mol of para-phenylenediamine, 0.4 mol of a functional diamine represented by Chemical Formula 24, and 0.3 mol of 4-(3,5-diaminobenzyloxy)phenyl methacrylate are used. The obtained liquid crystal alignment agent has a solid content of 10 wt %. In addition, the polyimide (PSPI-10) has a weight average molecular weight of 200,000.

### Example 11

### Preparation of Liquid Crystal Alignment Agent Including Polyimide (PSPI-11)

A liquid crystal alignment agent including polyimide (PSPI-11) is prepared in accordance with the same procedure as in Example 2, except that 0.3 mol of para-phenylenediamine, 0.4 mol of a functional diamine represented by Chemical Formula 25, and 0.3 mol of 4-(3,5-diaminobenzyloxy)phenyl methacrylate are used. The obtained liquid crystal alignment agent has a solid content of 10 wt %. In addition, the polyimide (PSPI-11) has a weight average molecular weight of 190,000.

### Example 12

### Preparation of Liquid Crystal Alignment Agent Including Polyimide (PSPI-12)

A liquid crystal alignment agent including polyimide (PSPI-12) is prepared in accordance with the same procedure as in Example 3, except that 0.3 mol of para-phenylenediamine, 0.4 mol of a functional diamine represented by Chemical Formula 26, and 0.3 mol of 4-(3,5-diaminobenzyloxy)phenyl methacrylate are used. The obtained liquid crystal alignment agent has a solid content of 10 wt %. In addition, the polyimide (PSPI-12) has a weight average molecular weight of 210,000.

### Comparative Example 1

### Preparation of Liquid Crystal Alignment Agent Including Polyimide (PSPI-13)

A liquid crystal alignment agent including polyimide (PSPI-13) is prepared in accordance with the same procedure as in Example 1, except that 0.8 mol of para-phenylenediamine and 0.2 mol of a functional diamine represented by Chemical Formula 24 are used, and 4-(3,5-diaminobenzyloxy)phenyl methacrylate is not used. The obtained liquid crystal alignment agent has a solid content of 10 wt %. In addition, the polyimide (PSPI-13) has a weight average molecular weight of 190,000.

### Comparative Example 2

### Preparation of Liquid Crystal Alignment Agent Including Polyimide (PSPI-14)

A liquid crystal alignment agent including polyimide (PSPI-14) is prepared in accordance with the same procedure as in Example 2, except that 0.8 mol of para-phenylenediamine and 0.2 mol of a functional diamine represented by Chemical Formula 25 are used, and 4-(3,5-diaminobenzyloxy)phenyl methacrylate is not used. The obtained liquid crystal alignment agent has a solid content of 10 wt %. In addition, the polyimide (PSPI-14) has a weight average molecular weight of 200,000.

### Comparative Example 3

### Preparation of Liquid Crystal Alignment Agent Including Polyimide (PSPI-15)

A liquid crystal alignment agent including polyimide (PSPI-15) is prepared in accordance with the same procedure as in Example 3, except that 0.8 mol of para-phenylenediamine and 0.2 mol of a functional diamine represented by Chemical Formula 26 are used, and 4-(3,5-diaminobenzyloxy)phenyl methacrylate is not used. The obtained liquid crystal alignment agent has a solid content of 10 wt %. In addition, the polyimide (PSPI-15) has a weight average molecular weight of 210,000.

### Experimental Example 1

### Evaluation of Vertical Alignment Properties of Liquid Crystal Alignment Film (Measurement of Pretilt Angle Difference (Δpretilt) from Standard Liquid Crystal Cell)

A liquid crystal cell is used to evaluate vertical alignment properties of liquid crystal alignment agents. The liquid crystal cell is fabricated as follows.

Standard indium-tin-oxide (ITO) coated glass substrates are patterned by photolithography to remove the ITO coating except for a 3 cm×6 cm square-shaped area to provide an ITO electrode shape for applying a voltage.

The liquid crystal alignment agents of Examples 1 to 12 and Comparative Examples 1. to 3 are spin-coated to a thickness of 0.1 μm on the patterned ITO substrate and cured at a temperature of 80° C. and 220° C.

In order to measure the vertical alignment properties, a test liquid crystal cell is manufactured by a rubbing process, assembling process, and liquid crystal injecting process.

The vertical alignment properties of the obtained liquid crystal cells are observed using a perpendicularly polarized optical microscope. After observing the vertical alignment properties, a liquid crystal cell having good vertical alignment properties is selected as a standard liquid crystal cell, and the pretilt angle of the standard liquid crystal cell is designated as 90°. Then each liquid crystal cell is irradiated with UV energy while applying an electric field and pretilt angle is measured using a crystal rotation method. In Table 1, Δpretilt indicates the difference between the measured pretilt angle of each liquid crystal cell and the pretilt angle of the standard liquid crystal cell.

The criteria for evaluating the vertical alignment properties are as follows:

<Criteria for Evaluating Vertical Alignment Properties>

Good: the pretilt angle difference from the standard liquid crystal cell ranges from 0.3° to 4°.

Bad: the pretilt angle difference from the standard liquid crystal cell is less than 0.3° or more than 4°.

### Experimental Example 2

### Liquid Crystal Alignment Properties and Electrical Property

A liquid crystal cell is manufactured to evaluate liquid crystal alignment properties of liquid crystal alignment agents. Liquid crystal alignment is manufactured as follows:

Standard indium-tin oxide (ITO) coated glass substrates are patterned using photolithography to remove the ITO coating except for a 3 cm×6 cm square-shaped ITO area to provide an ITO electrode shape for applying a voltage.

The liquid crystal alignment agents obtained from Examples 1 to 12 and Comparative Examples 1 to 3 are spin coated on the patterned ITO substrate to provide a thickness of 0.1 μm, and cured at 80° C. and 220° C.

In order to measure the liquid crystal alignment properties, test liquid crystal cells are provided by performing an assembling process and a liquid crystal injecting process and without performing a rubbing process.

The obtained liquid crystal cells are irradiated with UV energy while applying an electrical field, and the liquid crystal alignment properties of each liquid crystal cell is measured using a perpendicularly polarized optical microscope. The criteria for evaluating the liquid crystal alignment properties are follows:

<Criteria for Evaluating Liquid Crystal Alignment Properties>

Good: finding no disclination

Bad: finding disclination

A voltage of 1V is applied to the obtained liquid crystal cells, and the voltage holding ratio (VHR) depending upon the temperature of each liquid crystal cell is measured. Also a voltage of −10V to +10V is applied to the obtained liquid crystal cells, and the residual DC (RDC) voltage of each liquid crystal cell is measured.

The voltage holding ratio indicates the degree that the charged voltage is maintained by the liquid crystal layer floated with extraneous power for a random period in an active matrix mode TFT-LCD, which preferably approaches 100%.

The residual DC voltage indicates voltage applied to the liquid crystal layer by adsorbing impurities of ionized liquid crystal layer to the alignment layer, in which lower is better. The method of measuring the residual DC voltage generally includes a method using a flicker, or a method of using electrical capacity change curved line (C-V) of liquid crystal layer depending upon DC voltage.

TABLE 1

| | | Voltage | Residual | | |
|---|---|---|---|---|---|
| | | holding | DC | | Liquid crystal |
| | Vertical | ratio | (by C-V) | Δpretilt | alignment |
| Sample | alignment | (%) | (mV) | (°) | properties |
| Example 1 | good | 98.9 | 55 | 0.38 | good |
| Example 2 | good | 98.9 | 68 | 0.40 | good |
| Example 3 | good | 98.9 | 50 | 0.37 | good |
| Example 4 | good | 98.8 | 62 | 0.67 | good |
| Example 5 | good | 98.7 | 58 | 0.69 | good |
| Example 6 | good | 98.8 | 61 | 0.66 | good |
| Example 7 | good | 98.5 | 69 | 0.86 | good |
| Example 8 | good | 98.6 | 65 | 0.81 | good |
| Example 9 | good | 98.5 | 68 | 0.81 | good |
| Example 10 | good | 98.9 | 59 | 0.38 | good |
| Example 11 | good | 98.8 | 52 | 0.31 | good |
| Example 12 | good | 98.8 | 58 | 0.35 | good |
| Comparative | good | 98.8 | 69 | 0.0 | bad |
| Example 1 | | | | | |
| Comparative | good | 98.9 | 59 | 0.0 | bad |
| Example 2 | | | | | |
| Comparative | good | 98.7 | 68 | 0.0 | bad |
| Example 3 | | | | | |

As shown in Table 1, since the liquid crystal alignment agents obtained from Examples 1 to 12 have good vertical alignment properties, liquid crystal alignment properties and electrical properties, they may be effectively used for a liquid crystal alignment film. On the other hand, the liquid crystal alignment agents obtained from Comparative Examples 1 to 3 have good vertical alignment properties and electrical properties, but they have poor liquid crystal alignment properties and thus have limited use in a liquid crystal alignment film.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A liquid crystal alignment agent, comprising a polymer selected comprising polyamic acid including a repeating unit represented by the following Chemical Formula 1, polyimide including a repeating unit represented by the following Chemical Formula 2, or a combination thereof. 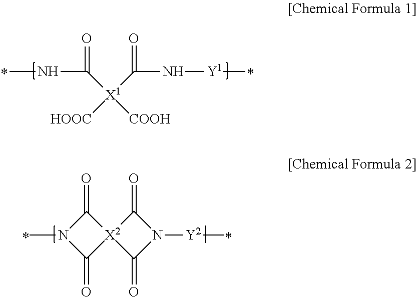
wherein, in Chemical Formulae 1 and 2,
X¹ and X² are the same or different and are each independently an tetravalent organic group derived from alicyclic acid dianhydride or aromatic acid dianhydride,
Y¹ and Y² are the same or different and are each independently a divalent organic group derived from diamine, wherein the diamine is represented by the following Chemical Formula 3, 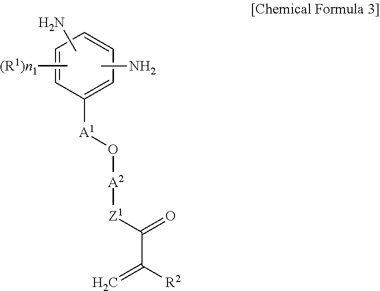
wherein, in Chemical Formula 3,
each R¹ is independently hydrogen, substituted or unsubstituted C1 to C30 aliphatic organic group, or substituted or unsubstituted C2 to C30 aromatic organic group,
n₁ is an integer ranging from 0 to 3,
A¹ is substituted or unsubstituted C1 to C20 alkylene,
A² is a single bond, substituted or unsubstituted divalent C1 to C20 aliphatic organic group, substituted or unsubstituted divalent C2 to C30 aromatic organic group, or substituted or unsubstituted divalent C3 to C30 alicyclic organic group,
Z¹ is a single bond, oxygen (0), substituted or unsubstituted divalent C1 to C20 aliphatic organic group, substituted or unsubstituted divalent C2 to C30 aromatic organic group, or substituted or unsubstituted divalent C3 to C30 alicyclic organic group, and
R² is hydrogen (H) or methyl (CH₃).

2. The liquid crystal alignment agent of claim 1, wherein the diamine represented by the above Chemical Formula 3 comprises a compound represented by the following Chemical Formulae 4 to 8 or a combination thereof:

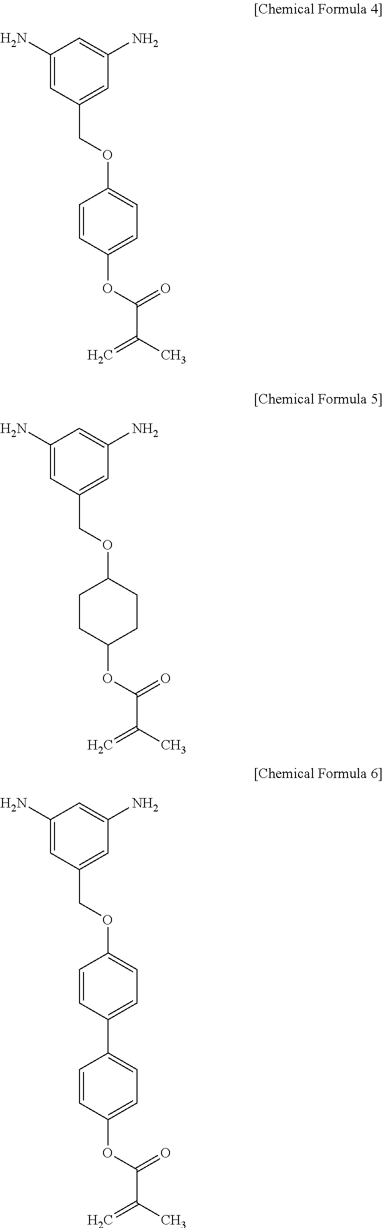

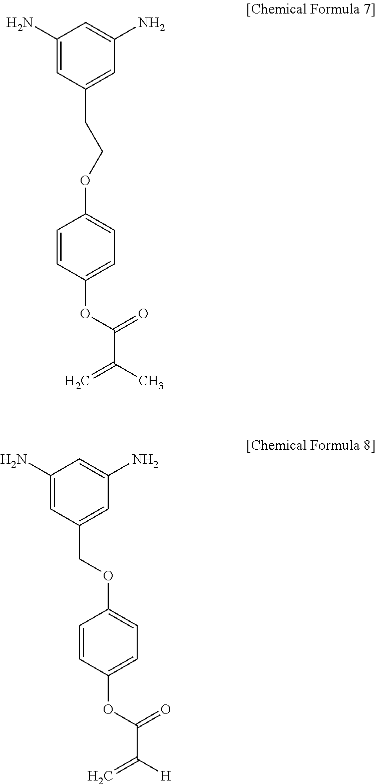

3. The liquid crystal alignment agent of claim 1, wherein the diamine further comprises one or more aromatic diamines represented by the following Chemical Formulae 16 to 19, one or more functional diamines represented by the following Chemical Formulae 20 to 22, or a combination of one or more of said aromatic diamines represented by the following Chemical Formulae 16 to 19 and one or more of said functional diamines represented by the following Chemical Formulae 20 to 22: 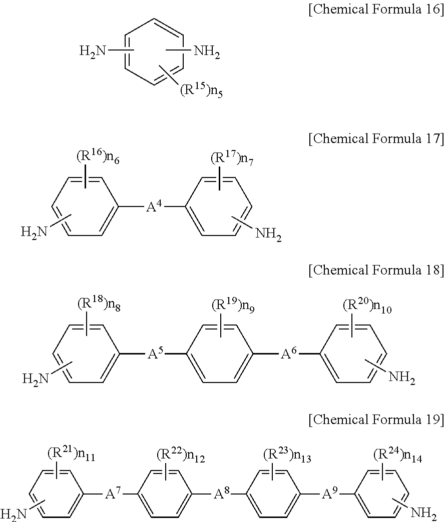
wherein, in Chemical Formulae 16 to 19,
R¹⁵ to R²⁴ are the same or different and are each independently substituted or unsubstituted alkyl, substituted or unsubstituted aryl, or substituted or unsubstituted heteroaryl, wherein the alkyl, aryl, and heteroaryl may optionally include —O—, —COO—, —CONH—, —OCO—, or a combination thereof,
A⁴ to A⁹ are the same or different and are each independently a single bond, O, SO₂ or C(R¹⁰³)R¹⁰⁴), wherein R¹⁰³ and R¹⁰⁴ are the same or different and are each independently hydrogen or substituted or unsubstituted C1 to C6 alkyl, and
n₅ to n₁₄ are each independently integers ranging from 0 to 4, 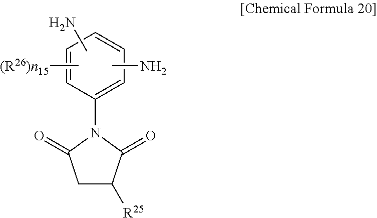
wherein, in Chemical Formula 20,
R²⁵ is hydrogen, substituted or unsubstituted C1 to C30 alkyl, substituted or unsubstituted C6 to C30 aryl, or substituted or unsubstituted C2 to C30 heteroaryl,
each R²⁶ is the same or different and is each independently substituted or unsubstituted C1 to C30 alkyl, substituted or unsubstituted C6 to C30 aryl, or substituted or unsubstituted C2 to C30 heteroaryl, and
n₁₅ is an integer ranging from 0 to 3, 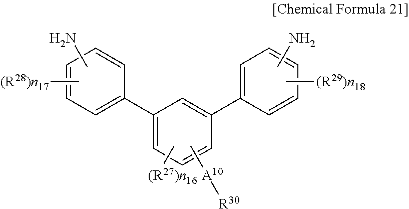
wherein, in Chemical Formula 21,
R²⁷, R²⁸ and R²⁹ are the same or different and are each independently substituted or unsubstituted alkyl, substituted or unsubstituted aryl, or substituted or unsubstituted heteroaryl,
A¹⁰ is a single bond, O, COO, CONH, OCO, or substituted or unsubstituted C1 to C10 alkylene,
R³⁰ is hydrogen, substituted or unsubstituted alkyl, substituted or unsubstituted aryl, or substituted or unsubstituted heteroaryl, wherein the alkyl, aryl, and heteroaryl may optionally include —O—, —COO—, —CONH—, —OCO—, or a combination thereof,
n₁₆ is an integer ranging from 0 to 3, and
n₁₇ and n₁₈ are each independently integers ranging from 0 to 4, 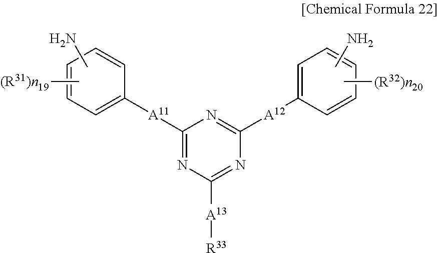
wherein, in Chemical Formula 22,
R³¹ and R³² ‘are the same or different and are each independently substituted or unsubstituted alkyl, substituted or unsubstituted aryl, or substituted or unsubstituted heteroaryl,
n₁₉ and n₂₀ are each independently integers ranging from 0 to 4,
R³³ is hydrogen, substituted or unsubstituted alkyl, substituted or unsubstituted aryl, or substituted or unsubstituted heteroaryl,
A¹¹ and A¹² are the same or different and are each independently a single bond, O, or COO, and
A¹³ is a single bond, O, COO, CONH, or OCO.

4. The liquid crystal alignment agent of claim 3, wherein the diamine comprises about 1 mol % to about 70 mol % of diamine represented by the above Chemical Formula 3, about 5 mol % to about 80 mol % of the aromatic diamine, and about 1 mol % to about 50 mol % of the functional diamine.

5. The liquid crystal alignment agent of claim 1, wherein the polyamic acid has a weight average molecular weight of about 10,000 to about 300,000.

6. The liquid crystal alignment agent of claim 1, wherein the polyimide has a weight average molecular weight of about 10,000 to about 300,000.

7. The liquid crystal alignment agent of claim 1, wherein the liquid crystal alignment agent comprises the polyamic acid and the polyimide at a weight ratio of about 1:99 to about 50:50.

8. The liquid crystal alignment agent of claim 1, wherein the liquid crystal alignment agent comprises about 1 wt % to about 25 wt % of a solid.

9. A liquid crystal alignment film manufactured by applying the liquid crystal alignment agent of claim 1 to a substrate.

10. A liquid crystal display device comprising the liquid crystal alignment film of claim 9.
